(19) United States
(12) Patent Application Publication
(10) Pub. No.: US 2021/0294899 A1
(43) Pub. Date: Sep. 23, 2021

(54) SEMICONDUCTOR DEVICE AND METHOD FOR CONTROLLING SEMICONDUCTOR DEVICE

(71) Applicant: KIOXIA CORPORATION, Tokyo (JP)

(72) Inventors: Takeshi SAKAMOTO, Fujisawa Kanagawa (JP); Hidekazu Nanzawa, Sagamihara Kanagawa (JP); Seiji Matsumoto, Yokohama Kanagawa (JP)

(21) Appl. No.: 17/009,349

(22) Filed: Sep. 1, 2020

(30) Foreign Application Priority Data
Mar. 18, 2020 (JP) 2020-048248

(51) Int. Cl. G06F 21/57; G06F 21/44; G06F 3/06

(52) U.S. Cl. CPC G06F 21/572; G06F 3/0679; G06F 21/44

(57) ABSTRACT

According to one embodiment, a semiconductor device includes a memory controller and a memory device. The memory device stores firmware comprising a first portion and a second portion that is loaded after the first portion has been loaded at startup. The memory device also stores a stored authentication value that is based on the first portion of the firmware. The memory controller is configured to generate a authentication value from the first portion once the first portion has been loaded at startup.

### CROSS-REFERENCE TO RELATED APPLICATION

This application is based upon and claims the benefit of priority from Japanese Patent Application No. 2020-048248, filed Mar. 18, 2020, the entire contents of which are incorporated herein by reference.

### FIELD

Embodiments described herein relate generally to a semiconductor device and a method of controlling a semiconductor device.

### BACKGROUND

Memory cards typically authenticate the firmware to be loaded at the time of startup for detecting whether the firmware has been tampered with. However, such a function may increase startup times.

### BRIEF DESCRIPTION OF THE DRAWINGS

FIG. 1 is a diagram of a semiconductor device according to an embodiment.

FIG. 2 is a flowchart depicting aspects of a method of controlling a semiconductor device according to an embodiment.

FIG. 3 is a diagram of a semiconductor device according to a comparative example.

FIG. 4 is a flowchart depicting aspects of a method of controlling a semiconductor device according to the comparative example.

### DETAILED DESCRIPTION

In general, according to one embodiment, a semiconductor device includes a memory controller and a memory device. The memory device stores firmware comprising a first portion and a second portion that is loaded after the first portion has been loaded at startup. The memory device also stores a stored authentication value that is based on the first portion of the firmware. The memory controller is configured to generate a authentication value from the first portion once the first portion has been loaded at startup.

Hereinafter, certain example embodiments of the present disclosure will be described with reference to drawings. In the description below, the same or substantially similar elements are denoted by the same reference numerals. However, it should be noted that the drawings are schematic and any depicted relationship between various component or aspect dimensions, such as thickness or planar sizes can be different from those utilized in actuality.

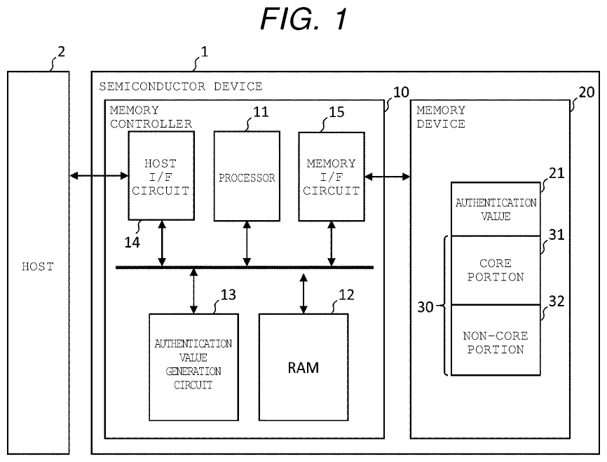

FIG. 1 is a diagram showing a configuration of a semiconductor device 1 according to the present example embodiment. As shown in FIG. 1, the semiconductor device 1 is a storage medium that can be detachably connected to a host 2 or housed inside the host 2. The host 2 is, for example, a personal computer or a digital camera. In this example, semiconductor device 1 is in the form of a memory card such as an SD Card™.

The semiconductor device 1 includes a memory controller 10 and a memory device 20. The memory controller 10 includes a processor 11, a random access memory (RAM) 12, an authentication value generation circuit 13, a host interface (I/F) circuit 14, and a memory interface (I/F) circuit 15, which are all connected via a bus.

Examples of the processor 11 include a central processing unit (CPU) and a micro-processing unit (MPU).

The memory device 20 stores firmware 30 and an authentication value 21. These are loaded into the RAM 12 when the semiconductor device 1 starts up (initializes). The authentication value 21 is a value generated from a calculation by the authentication value generation circuit 13 based on a core portion 31 of the firmware 30. That is, the authentication value 21 can be calculated (generated) using just the core portion 31, and a non-core portion 32 of the firmware 30 is not required or utilized in this process. The memory device 20 is, for example, a NAND flash memory.

As noted, the firmware 30 of the present embodiment has a core portion 31 and a non-core portion 32. For startup, the core portion 31 is loaded into the RAM 12 of the memory controller 10 before the non-core portion 32. The non-core portion 32 is loaded into the RAM 12 of the memory controller 10 only after the core portion 31 is loaded into the RAM 12 of the memory controller 10 and an authentication using the stored and calculated authentication values has been performed. The core portion 31 includes, for example, boot functions and boot info. The data size of the core portion 31 is preferably set to a size that can be read from the memory device 20 at one time. That is, the core portion 31 is preferably one read unit or less in size. For example, if a NAND flash memory is used as the memory device 20, it is desirable that the data size of the read data transmitted from the memory device 20 to the memory controller 10 is equal to or less than one page in size.

As the authentication value 21, for example, a hash value or a MAC value generated by a verification technique such as hash or a message authentication code (MAC), which is a countermeasure against data tampering, may be used. A method of detecting data corruption (or the lack thereof), such as an electronic signature, a checksum, a cyclic redundancy check (CRC), or a data comparison of a specific address, or another method may be used. Typical examples of the authentication method include message-digest algorithm 5 (MD5) and secure hash algorithm (SHA) in hash, and hash-based MAC (HMAC) and cipher-based MAC (CMAC) in MAC. In addition, there are many algorithms such as RSA (Rivest-Shamir-Adleman) signature in the electronic signature, and, in general, any such cryptosystem algorithm may be used in the present embodiment.

The semiconductor device 1 according to the present embodiment has a function of preventing aftermarket tampering with the firmware 30, such as prohibiting writing to an area of the memory device 20 in which the firmware 30 is stored.

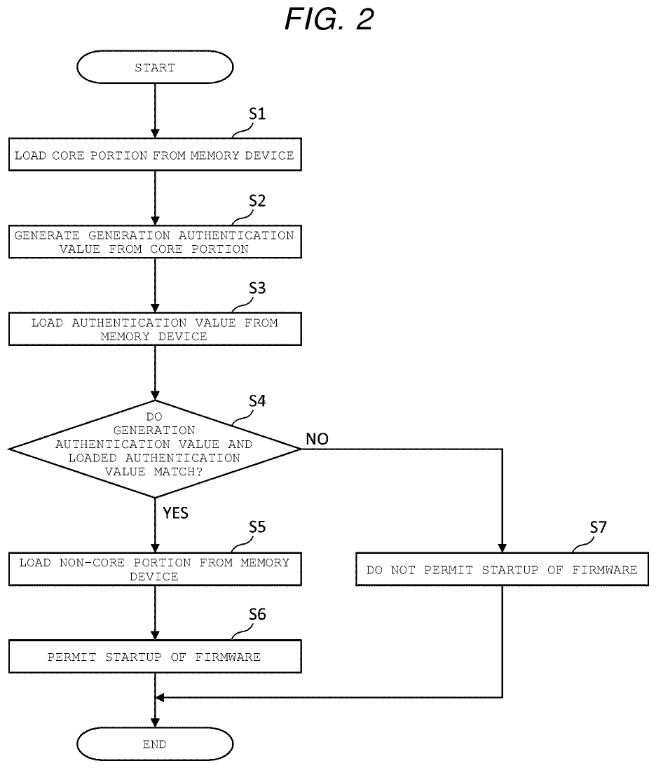

FIG. 2 is a flowchart showing a method for controlling the semiconductor device according to the present embodiment.

First, when a supply of a power supply voltage to the semiconductor device 1 is started from the host 2 or the like via the host I/F circuit 14 (that is, a power-on instruction or the like is received), the core portion 31 of the firmware 30 is loaded from the memory device 20 via the memory I/F circuit 15 into the RAM 12 of the memory controller 10 (step S1). Next, the authentication value generation circuit 13 generates an authentication value (also referred to as a check value or a generated authentication value) from the core portion 31 (step S2). The stored authentication value 21 is read from the memory device 20 to the RAM 12 of the memory controller 10 (step S3). The processor 11 compares the generated authentication value to the authentication value 21 (loaded in step S3 and thus also referred to in this context as the loaded authentication value) and determines whether both values match (step S4). When it is determined that the both match, the comparison result is YES, and the non-core portion 32 is then loaded from the memory device 20 into the RAM 12 (step S5). The startup of the firmware 30 is then permitted by the processor 11 (step S6), and the processing ends. On the other hand, when it is determined in step S4 that the both authentication values do not match (comparison result is NO), the startup of the firmware 30 is not permitted (step S7), and the processing ends.

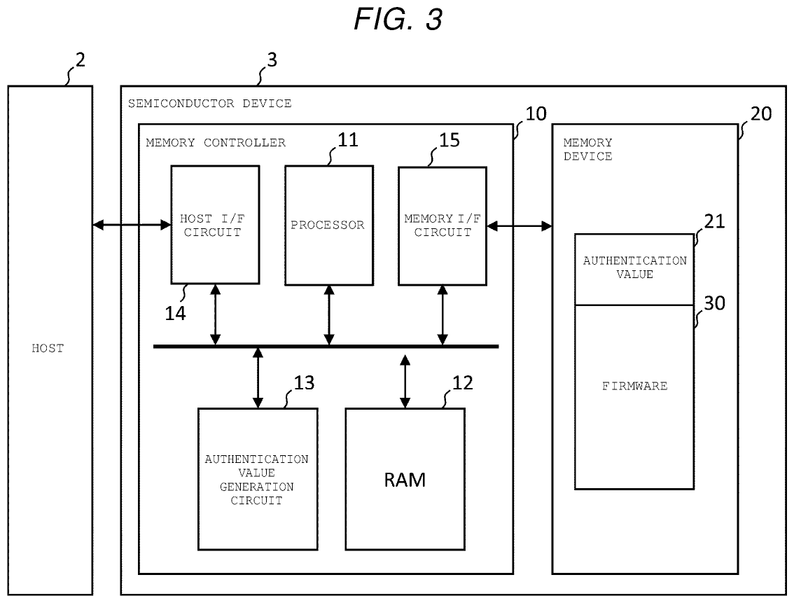

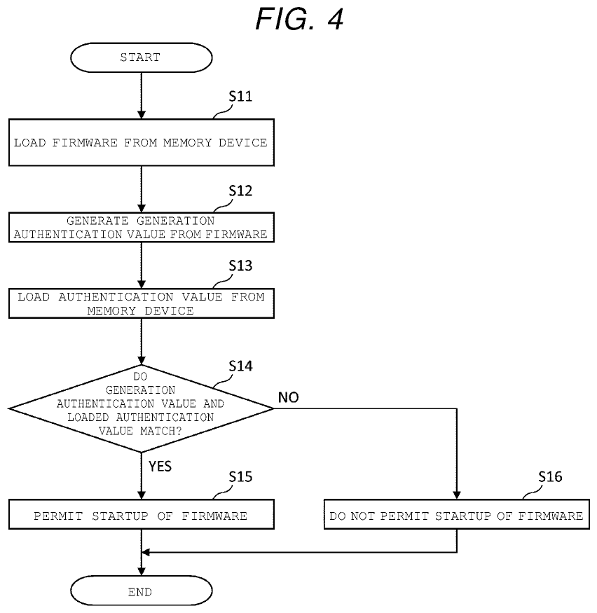

Next, the present embodiment is compared to a comparative example, which is described with reference to FIGS. 3 and 4. FIG. 3 is a diagram showing a configuration of a semiconductor device 3 according to the comparative example.

In the semiconductor device 3 according to the comparative example, a core portion is not separately defined in the firmware 30 stored in the memory device 20. That is, the firmware 30 has no core portion 31. Furthermore, since a core portion is not defined in the comparative example, the generated authentication value to be compared to the stored authentication value 21 results from a calculation by the authentication value generation circuit 13 performed after all of the firmware 30 has been loaded. Since the comparative example has no core portion 31, there is no non-core portion 32 of the firmware.

FIG. 4 is a flowchart showing a method for controlling the semiconductor device 3 according to the comparative example. First, when the supply of a power supply voltage from the host 2 or the like to the semiconductor device 3 is started (that is, a power-on instruction is received), the firmware 30 is loaded from the memory device 20 into the RAM 12 of the memory controller 10 (step S11). Next, the authentication value generation circuit 13 calculates a authentication value (a check value or generated authentication value) from the firmware 30 (step S12). The authentication value 21 is loaded from the memory device 20 into the RAM 12 of the memory controller 10 (step S13). The processor 11 compares the generated authentication value to the loaded authentication value 21 (loaded in step S13) and determines whether both match (step S14). When it is determined that both match, the comparison result is YES, the startup of the firmware 30 is permitted (step S15), and the processing ends. On the other hand, when it is determined in step S14 that both do not match (comparison result is NO), the startup of the firmware 30 is not permitted (step S16), and the processing ends.

In the comparative example, the entire firmware 30 is used for generating a check value (generated authentication value) when the semiconductor device 3 is started up. On the other hand, in the semiconductor device 1 according to the present embodiment, only the core portion 31 of the firmware 30 is used for generating a generation authentication value when starting up. Since the size of the core portion 31 can be set to a size permitting the core portion 31 to be read from the memory device 20 in one reading cycle, it is possible to reduce the load time, and similarly the generation time of the authentication value (check) as compared with the comparative example in which the data of the firmware 30 needs to be read over two or more cycles. Furthermore, the semiconductor device 1 helps prevents aftermarket (post-sale or manufacturing) tampering with the firmware 30. Therefore, even when only a core portion 31 of the firmware 30 is used for generating a generation authentication value, it is still possible to obtain an effective authentication process using generation of authentication values.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A semiconductor device, comprising:
a memory controller; and
a memory device storing:
firmware comprising a first portion and a second portion that is loaded after the first portion has been loaded at startup, and
a stored authentication value that is based on the first portion, wherein
the memory controller is configured to generate a authentication value from the first portion once the first portion has been loaded at startup.

2. The semiconductor device according to claim 1, wherein the memory controller includes an authentication value generation circuit configured to generate the authentication value from the first portion.

3. The semiconductor device according to claim 1, wherein the first portion includes boot information associated with startup.

4. The semiconductor device according to claim 1, wherein the memory device comprises NAND flash memory.

5. The semiconductor device according to claim 1, wherein the memory controller includes random access memory, and the firmware is loaded to the random access memory during startup.

6. The semiconductor device according to claim 1, wherein the first portion is equal to or less than a read unit of the memory device in data size.

7. The semiconductor device according to claim 1, wherein the read unit is one page in data size.

8. The semiconductor device according to claim 1, wherein the memory controller is further configured to perform an authentication operation that includes comparing the stored authentication value to the generated authentication value and permitting completion of startup based on the firmware only when the stored authentication value and the generated authentication value match.

9. The semiconductor device according to claim 8, wherein the second portion is loaded by the memory controller only if the stored authentication value and the generated authentication value match.

10. The semiconductor device according to claim 1, wherein the authentication value is generated from the first portion as a hash value or a message authentication code (MAC) value.

11. The semiconductor device according to claim 1, wherein the authentication value is generated an electronic signature, a checksum, a cyclic redundancy check, or a data comparison.

12. The semiconductor device according to claim 1, further comprising:
a host interface configured to connect the memory controller to a host device.

13. A memory system, comprising:
a host device;
a memory controller connected to the host device; and
a memory device connected to the memory controller and storing firmware comprising a first portion and a second portion that is loaded after the first portion has been loaded at startup, the memory device further storing a stored authentication value that is based on the first portion of the firmware, wherein
the memory controller is configured to generate a authentication value from the first portion once the first portion has been loaded at startup.

14. The memory system according to claim 13, wherein the memory controller includes an authentication value generation circuit configured to generate the authentication value from the first portion.

15. The memory system according to claim 13, wherein the first portion includes boot information associated with startup.

16. The memory system according to claim 13, wherein the first portion is equal to or less than a read unit of the memory device in data size.

17. The memory system according to claim 13, wherein the memory controller is further configured to perform an authentication operation that includes:
comparing the stored authentication value to the generated authentication value, and
permitting completion of startup based on the firmware only when the stored authentication value and the generated authentication value match.

18. The memory system according to claim 17, wherein the second portion is loaded by the memory controller only if the stored authentication value and the generated authentication value match.

19. A method for controlling a semiconductor device, the method comprising:
upon startup, loading a first portion of firmware from a memory device storing firmware and a stored authentication value, generating an authentication value from the first portion of firmware;
comparing the stored authentication value to the generated authentication value; and
permitting completion of startup only if the stored authentication value and the generated authentication value match.

20. The method according to claim 19, wherein the completion of startup includes loading a second portion of the firmware after the loading of the first portion.
